(19) United States
(12) Patent Application Publication
(10) Pub. No.: US 2022/0307810 A1
(43) Pub. Date: Sep. 29, 2022

(54) MEASURING DEVICE

(71) Applicant: FUJITSU COMPONENT LIMITED, Tokyo (JP)

(72) Inventor: Koichiro FUJI, Tokyo (JP)

(73) Assignee: FUJITSU COMPONENT LIMITED, Tokyo (JP)

(21) Appl. No.: 17/281,373

(22) PCT Filed: Sep. 30, 2020
(86) PCT No.: PCT/JP2020/037340

§ 371 Date: Mar. 30, 2021

(51) Int. Cl. G01B 3/1069; G01B 3/1094

(52) U.S. Cl. CPC G01B 3/1069; G01B 3/1094

(57) ABSTRACT

A measuring device includes a measure, a reel around which the measure is wound, the reel rotating according to pulling-out of the measure and being provided with a code pattern that changes along a rotation direction, a reader configured to optically read the code pattern, and a calculator configured to calculate a measurement value of the measure from a reading result by the reader.

### CROSS REFERENCE TO RELATED APPLICATIONS

This application is a U.S. National Stage Application which claims the benefit under 35 U.S.C. § 371 of International Patent Application No. PCT/JP2020/037340 filed on Sep. 30, 2020, the contents of which are incorporated herein by reference.

### TECHNICAL FIELD

The present invention relates to a measuring device.

### BACKGROUND ART

Regarding a measuring device including a measure, Patent Document 1 describes that a length is measured by recognizing an image of a scale of the measure.

### PRIOR ART DOCUMENTS

### Patent Document

Patent Document 1: Japanese Laid-open Patent Publication No. 2011-7607

### SUMMARY OF THE INVENTION

### Problem to be Solved by the Invention

However, since the measure is pulled out from a main body of the measuring device and applied to an object to be measured, dirt easily adheres to the measure, which may cause an error in a measured value. The dirt such as mud and oil easily adhere to the measure that is often used outdoors, such as a convex measure.

It is an object of the present invention to provide a measuring device capable of improving a measurement accuracy.

### Means for Solving the Problem

According to an aspect, a measuring device includes a measure, a reel around which the measure is wound, the reel rotating according to pulling-out of the measure and being provided with a code pattern that changes along a rotation direction, a reader configured to optically read the code pattern, and a calculator configured to calculate a measurement value of the measure from a reading result by the reader.

### Effects of the Invention

According to the present invention, it is possible to improve a measurement accuracy.

### BRIEF DESCRIPTION OF THE DRAWINGS

FIG. 1 is an exploded perspective view (part 1) illustrating an example of the measuring device;

FIG. 2 is an exploded perspective view (part 2) illustrating an example of the measuring device;

FIG. 3 is a configuration diagram illustrating an example of an electrical configuration of the measuring device;

FIGS. 4A and 4B are diagrams illustrating the operation of reading a code pattern by a light emitting element and a light receiving element;

FIG. 5A is a diagram illustrating an example of a value read from the code pattern;

FIG. 5B is a diagram illustrating an example of detection operation by a detection circuit;

FIG. 6 is a flowchart illustrating an example of the operation of a microcomputer; and

FIG. 7 is a flowchart illustrating an example of a determination process of rotation of a reel.

### EMBODIMENTS FOR CARRYING OUT THE INVENTION

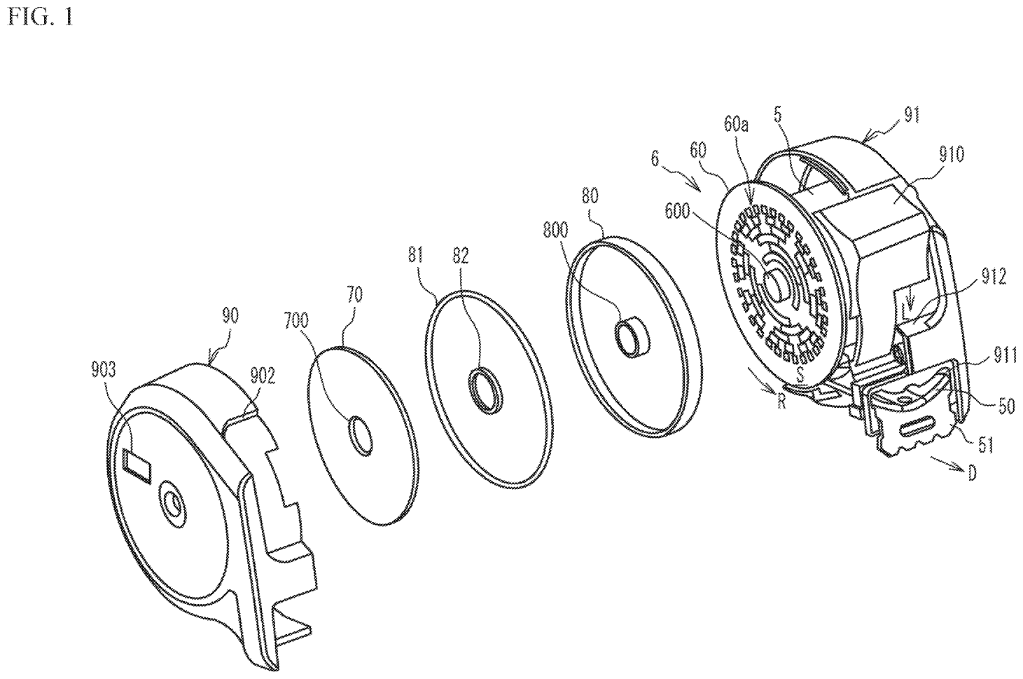

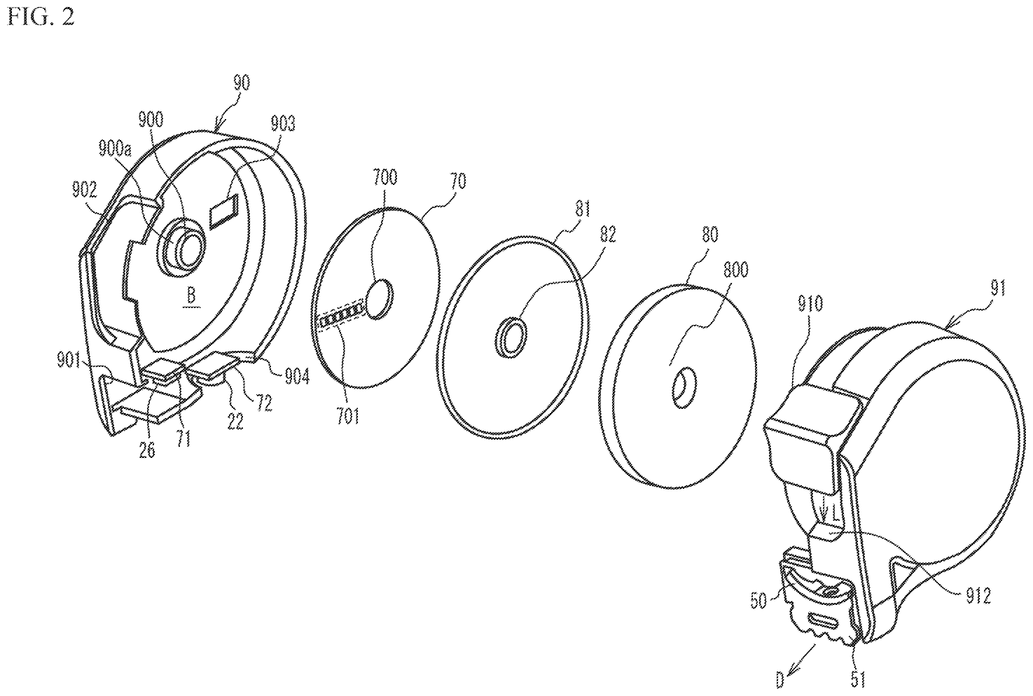

FIGS. 1 and 2 are exploded perspective views illustrating an example of a measuring device. The measuring device includes a pair of cases 90, 91, a measure 5, a reel 6, a cover 80, packings 81, 82, a main substrate 70, and sub-substrates 71, 72.

The cases 90 and 91 are examples of first and second cases, respectively. Each of the cases 90 and 91 has a substantially cylindrical shape and is made of a resin or the like. The cases 90, 91 are detachable from each other. The case 91 houses the measure 5 and the reel 6, and the case 90 houses the main substrate 70 and sub-substrates 71, 72.

The reel 6 is made of a resin or the like as an example, and has a cylindrical shape, for example. The reel 6 is rotatably attached to the cases 90 and 91 so as to cooperate with the pulling-out of the measure 5 along a direction D. A flange-shaped flange 60 is provided on a side surface of the reel 6 facing the case 90. The measure 5 is wound around the reel 6. The reel 6 is urged by an elastic body such as a spring so as to wind up the measure 5.

The measure 5 is made of a metal, for example, and is used to measure a length of an object to be measured. A scale is printed on one side of the measure 5. A tip 50 of the measure 5 is exposed from an opening 911 of the case 91. The tip 50 is provided with a hook 51 that is locked around the opening 911 in order to prevent the tip 50 from being wound around the reel 6 and being pulled back into the case 91.

A lock lever 910 for stopping or releasing the winding of the measure 5 is provided above the opening 911 of the case 91. The lock lever 910 is mounted so as to be slidable on recesses 912 and 902 of the cases 90 and 91. When the lock lever 910 is in an unlocked state illustrated, the measure 5 is wound around the reel 6 by an urging force of the elastic body.

When the lock lever 910 is slid in a direction L, the lock lever 910 is locked and suppresses the winding of the measure 5. A user can stop the winding of the measure 5 by locking the lock lever 910 while the measure 5 is being applied to the object to be measured.

The flange 60 has a disk shape, and a circular convex-shaped shaft 600 is provided at the center of a surface S facing the case 90. The shaft 600 is inserted into a circular concave shaft receiver 900 provided at the center of a bottom surface B of the facing case 90. Therefore, the reel 6 can rotate in a direction R about the shaft 600 while the measure 5 is being pulled out from the opening 911 in the direction D.

A code pattern 60a is provided around the shaft 600 on the surface S. The code pattern 60a is a gray code pattern, for example, and change along the rotation direction R of the reel 6. A rotation number and a rotation angle of the reel 6 can be calculated using the code pattern 60a. As an example, each code pattern 60a is formed by a hole provided on the surface S.

The circular main substrate 70 is provided on the bottom surface B of the case 90. The main substrate 70 is a circuit substrate on which electronic components are mounted. One surface of the main substrate 70 faces the bottom surface B. Further, the other surface of the main substrate 70 faces the surface S of the flange 60, and a reading sensor 701 that reads the code pattern 60a is mounted on the other surface of the main substrate 70. The reading sensor 701 has a plurality of sets of pairs of light emitting elements and light receiving elements arranged in a row, as described later. A measurement value of the measure 5 is calculated from a value of the code pattern 60a read by the reading sensor 701 and transmitted to other device.

A through hole 700 fitted to an outer peripheral wall 900a of the shaft receiver 900 is provided at the center of the main substrate 70. Thereby, the main substrate 70 is fixed at a predetermined position with respect to the case 90. The main substrate 70 is provided with a microcomputer, a communication processing unit and a display unit, as described later.

A window 903 is provided at a position of the bottom surface B corresponding to the display unit on the main substrate 70. The window 903 is made of a transparent resin or the like, for example. The user confirms display content of the display unit through the window 903.

The sub-substrates 71 and 72 are circuit substrates on which electric components are mounted. The sub-substrates 71 and 72 are electrically connected to the main substrate 70 via unillustrated electric cables. Although the main substrate 70 and the sub-substrates 71 and 72 are configured as separate substrates, they may be configured as a single substrate.

The sub-substrate 71 is provided at a position in the case 90 corresponding to the vicinity of the opening 911 of the case 91. The sub-substrate 71 is provided with a detection circuit 26 that detects the pulling-out of the measure 5. The detection circuit 26 has a set of a light emitting element and a light receiving element as described later.

The sub-substrate 72 is provided with a switch 22 for starting the measurement by the measure 5. The sub-substrate 72 is provided on the side of the main substrate 70 so that the switch 22 is exposed from a semicircular notch 904 provided on the outer peripheral wall of the case 90.

The cover 80 is fixed to the case 90 with screws or the like. The cover 80 separates the reel 6 and the reading sensor 701, and covers the reading sensor 701. The cover 80 has a circular dish shape, and has an annular insertion portion 800 through which the shaft 600 is inserted at the center of the cover 80. The cover 80 protects the reading sensor 701 from dirt such as mud on the measure 5. Since the cover 80 is made of the transparent resin or the like, for example, it does not interfere with the reading of the code pattern 60a by the reading sensor 701.

The packings 81 and 82 are made of an elastic member such as a rubber, and are used to improve the sealing of the measuring device. The packing 81 has a ring shape corresponding to an outer peripheral surface of the cover 80, and the packing 82 has a ring shape corresponding to the insertion portion 800 of the cover 80. By sandwiching the packing 81 between the cover 80 and the case 90, the main substrate 70 in the case 90 is sealed against the outside. Further, by sandwiching the packing 82 between the cover 80 and the main substrate 70, the main substrate 70 in the case 90 is sealed against the outside. Therefore, it is possible to prevent water or dust that has entered through, for example, the opening 911 from adhering to the main substrate 70.

Even if a foreign matter such as the water or dust enters the cases 90 and 91, the cases 90 and 91 are detachable from each other, and hence the foreign matter can be easily removed. Furthermore, the case 90 houses the main substrate 70 and the case 91 houses the reel 6. Therefore, even if the reel 6 fails, only the case 91 which houses the reel 6 can be replaced with a new case 91 and the new case 91 can be combined with the case 90, allowing the measurement device to be used again without discarding the expensive main substrate 70.

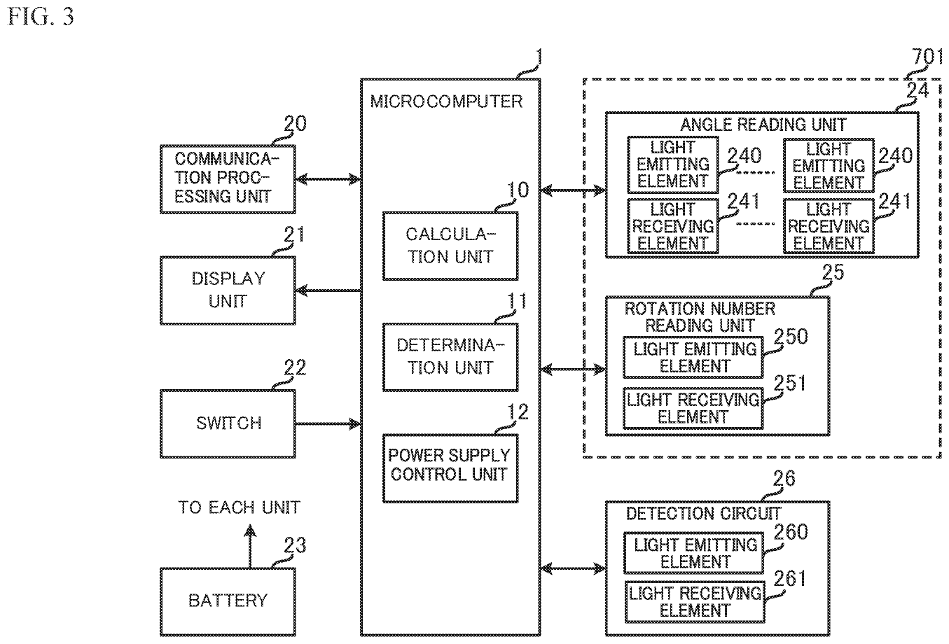

FIG. 3 is a configuration diagram illustrating an example of an electrical configuration of the measuring device. The measuring device includes a microcomputer 1, a communication processing unit 20, a display unit 21, the switch 22, a battery 23, the reading sensor 701 and the detection circuit 26.

For example, the microcomputer 1, the communication processing unit 20, the display unit 21, the battery 23 and the reading sensor 701 are mounted on the main substrate 70. Further, the switch 22 is mounted on the sub-substrate 72, and the detection circuit 26 is mounted on the sub-substrate 71, for example.

The microcomputer 1 is a circuit including a processor such as an unillustrated CPU (Central Processing Unit) and a memory storing a program for driving the processor. When the microcomputer 1 executes the program, it forms a calculation unit 10, a determination unit 11, and a power supply control unit (hereinafter referred to as “control unit”) 12 as software functions. The calculation unit 10, the determination unit 11 and the control unit 12 may be circuits composed of hardware such as an FPGA (Field Programmable Gate Array) or an ASIC (Application Specified Integrated Circuit).

The calculation unit 10 calculates the measurement value of the measure 5 from the code pattern 60a read by the reading sensor 701. The determination unit 11 determines the normality of rotation of the reel 6 based on a detection result of the detection circuit 26 and the change of the code pattern 60a read by the reading sensor 701. The control unit 12 controls the power supply to the reading sensor 701 and the detection circuit 26.

The communication processing unit 20 communicates with other devices such as a smartphone and a personal computer by means such as a wireless LAN (Local Area Network). The communication processing unit 20 includes a circuit, an antenna and the like that perform a baseband process. The communication processing unit 20 is an example of a transmission unit, and transmits the measurement value of the measure 5 calculated by the calculation unit 10 to the other device. Therefore, the measurement value of the measure 5 transmitted from the measuring device can be stored in the other device. Here, the communication processing unit 20 is not limited to wireless, but may communicate by wire.

The display unit 21 is a liquid crystal display, for example, and displays various types of information. A display surface of the display unit 21 is arranged so as to be visible from the window 903. The display unit 21 displays the occurrence of an abnormality when the determination unit 11 determines that there is the abnormality, for example. The measurement value calculated by the calculation unit 10 may be displayed on the display unit 21.

The switch 22 is pressed when the measurement of the measure 5 is executed. When the microcomputer 1 detects that the switch 22 is pressed, the microcomputer 1 executes a measurement process.

The battery 23 is a coin-type battery, for example, and supplies an electric power to the electric components such as a microcomputer 1.

The reading sensor 701 is an example of a reading unit, and optically reads the code pattern 60a provided on the flange 60. The reading sensor 701 has a reading unit 24 that reads the angle of the reel 6 from the code pattern 60a, and a reading unit 25 that reads the rotation number of the reel 6 from the code pattern 60a.

The reading unit 24 includes a plurality of sets of light emitting elements 240 and light receiving elements 241 arranged linearly. The reading unit 25 includes a set of a light emitting element 250 and a light receiving element 251. The detection circuit 26 includes a set of a light emitting element 260 and a light receiving element 261. The light emitting elements 240, 250 and 260 are LEDs (Light Emitting Diodes), for example, and the light receiving elements 241, 251 and 261 are phototransistors, for example, but the present invention is not limited thereto.

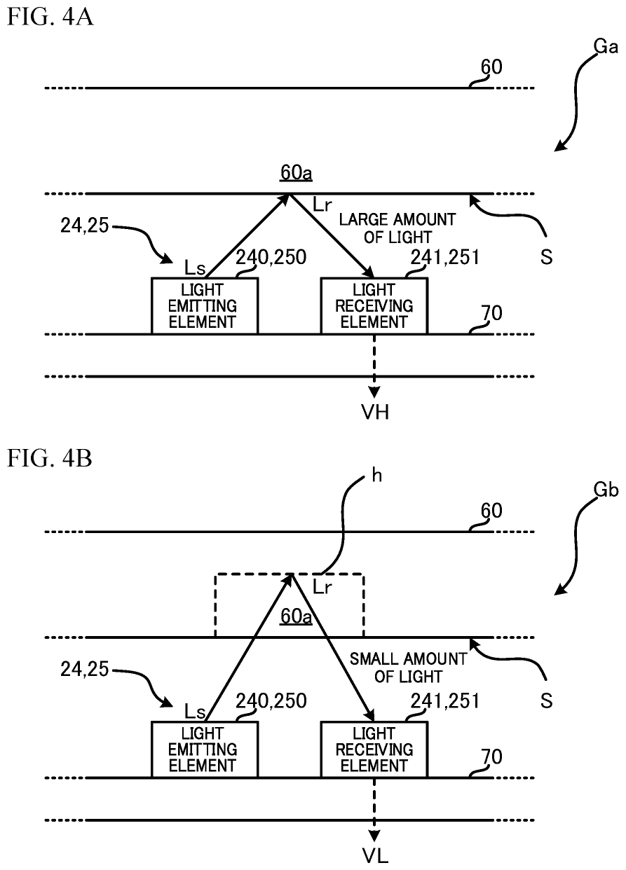

FIGS. 4A and 4B are diagrams illustrating the operation of reading the code pattern 60a by the light emitting elements 240 and 250 and the light receiving elements 241 and 251. FIGS. 4A and 4B illustrate the flange 60 and the main substrate 70 viewed from a side. The cover 80 is not illustrated.

The light emitting elements 240 and the light receiving elements 241 in the reading unit 24 and the light emitting element 250 and the light receiving element 251 in the reading unit 25 are mounted on the main substrate 70. The light emitting elements 240 and 250 irradiate the surface S of the flange 60 with light Ls. The light Ls is reflected by the surface S to become reflected light Lr. The reflected light Lr is incident on each of the light receiving elements 241 and 251.

A sign Ga illustrates an example of the reading operation of the code pattern 60a at a position without a hole h, and a sign Gb illustrates an example of the reading operation of the code pattern 60a at a position with the hole h. Each of the light receiving elements 241 and 251 outputs a current having an intensity corresponding to an amount of the incident reflected light Lr. The amount of the reflected light Lr from the position without the hole h is larger than the amount of the reflected light Lr from the position with the hole h (see “Large amount of light” and “Small amount of light”). This is because when there is the hole h, the light Ls and the reflected light Lr are attenuated according to a depth of the hole h.

For this reason, a current value output by each of the light receiving elements 241 and 251 according to the amount of reflected light Lr is also smaller when there is the hole h than when there is no hole h. Therefore, a voltage value VL obtained by converting the current value of each of the light receiving elements 241 and 251 when there is the hole h is smaller than a voltage value VH when there is no hole h. For example, the voltage value VL when there is the hole h is about 1/20 of the voltage value VH when there is no hole h. Thereby, the microcomputer 1 can identify a value of the code pattern 60a read at the position without the hole h as a binary number “1,”, and a value of the code pattern 60a read at the position with the hole h as a binary number “0”, for example.

A method for identifying the value of the code pattern 60a is not limited to this. The code pattern 60a may indicate different values depending on a difference in color painted on the surface S, for example. For example, the code pattern 60a may indicate the binary number “0” in black and the binary number “1” in white. At this time, the voltage value of each of the light receiving elements 241 and 251 in the case of black is about one-third of that in the case of white. This difference in voltage values allows the microcomputer 1 to identify the value of the code pattern 60a. The light emitting elements 240 and 250 and the light receiving elements 241 and 251 use visible light, but are not limited to this, and infrared, visible light, ultraviolet light or the like can be used to perform the same reading as described above.

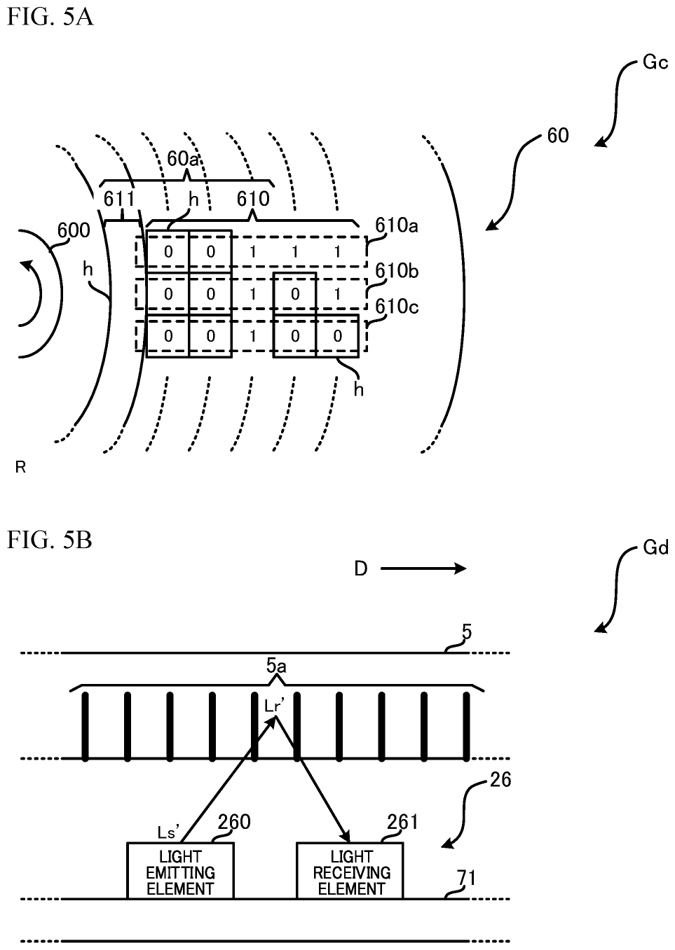

A code Gc in FIG. 5A illustrates an example of a value read from the code pattern 60a. The code pattern 60a includes a lane 611 used for determining the rotation number and five lanes 610 used for determining the rotation angle. The lane 611 is an example of a region indicating the rotation number of the reel 6, and the lane 610 is an example of a region indicating the rotation angle of the reel 6.

The lane 611 is provided with a total of two holes h having a length of one-fourth of a circumference at 90-degree intervals about the shaft 600. The light emitting element 250 and the light receiving element 251 are arranged at a position facing the lane 611, and the light receiving element 251 receives the reflected light from the flange 60 at a position without hole h in the lane 611. A portion of the lane 611 with the hole h corresponds to the binary number “0”, and a portion of the lane 611 without the hole h corresponds to the binary number “1”. The calculation unit 10 and the determination unit 11 identify and count a value of the lane 611 from a voltage value output from the light receiving element 251 to detect the rotation number of the reel 6.

As the reel 6 rotates in the rotation direction R, the value of the lane 611 changes every 90 degrees. The calculation unit 10 and the determination unit 11 recognize that the reel 6 rotated once when the value of the lane 611 changes to the binary numbers “0”, “1”, “0”, and “1”, and determine the rotation number of the reel 6 based on the number of detections of a pattern including “0”, “1”, “0” and “1”.

The five lanes 610 represent a five-digit binary value according to the gray code, for example. Each lane 610 is provided with a hole h at a position indicating the binary number “0”, and no hole h at a position indicating the binary number “1”. The light emitting element 240 and the light receiving element 241 are provided at a position facing each lane 610, and the light receiving element 241 receives the reflected light from the flange 60 at a position without hole h in the lane 610. The light emitting element 240 and the light receiving element 241 are provided for each digit of the binary number.

The calculation unit 10 identifies the value of each lane 610 from the voltage value output from the light receiving element 241 corresponding to each digit to detect the rotation angle of the reel 6. The rotation angle indicates an amount of displacement of the reel 6 in the rotation direction R with respect to the position of the reel 6 when the measure 5 is completely housed in the cases 90 and 91, for example.

As the reel 6 rotates in the rotation direction R, the position of the lane 610 facing the light emitting element 240 and the light receiving element 241 corresponding to each digit changes. When the light emitting element 240 and the light receiving element 241 of each digit face a position 610a, a binary number “00111” is read out. When the light emitting element 240 and the light receiving element 241 of each digit face a position 610b, a binary number “00101” is read out. When the light emitting element 240 and the light receiving element 241 of each digit face a position 610c, a binary number “00100” is read out.

The calculation unit 10 converts the read value of the lane 610 into the rotation angle according to a predetermined calculation formula. A table or the like may be used to calculate the rotation angle.

Since there is a correlation between an amount of the pulling-out of the measure 5 and the rotation number and the rotation angle of the reel 6, the calculation unit 10 calculates the measurement value of the measure 5 from the calculated rotation number and the calculated rotation angle. The measurement value can be calculated using a calculation formula, a table, or the like.

In this way, the light emitting elements 240 and 250 and the light receiving elements 241 and 251 optically read the code pattern 60a provided on the side surface of the reel 6 that rotates according to the pulling-out of the measure 5. The code pattern 60a changes along the rotation direction R of the reel 6. The calculation unit 10 calculates the measurement value of the measure 5 from the values read by the light emitting elements 240 and 250 and the light receiving elements 241 and 251.

According to the above configuration, since the code pattern 60a is provided on the reel 6, even if dirt such as mud or oil adheres to the measure 5, the dirt is less likely to adhere to the code pattern 60a. Thus, the calculation unit 10 can calculate the measurement value of the measure 5 with high accuracy. Therefore, the measurement accuracy of the measuring device can be improved.

The light emitting elements 240 and 250 and the light receiving elements 241 and 251 read the code pattern 60a according to the presence or absence of the hole h on the side surface of the reel. Therefore, as compared with the case where the code pattern 60a is read according to a paint color on the side surface of the reel 6, for example, the code pattern 60a can be read accurately even if the dirt adheres to the hole h.

The code pattern 60a has the lane 611 indicating the rotation number of the reel 6 and the plurality of lanes 610 indicating the rotation angle of the reel 6. The calculation unit 10 calculates the measurement value of the measure 5 from the rotation angle and the rotation number of the reel 6. Therefore, the calculation unit 10 can calculate the measurement value with high accuracy, compared with the case where the measurement value is calculated from only the rotation angle.

A code Gd in FIG. 5B illustrates an example of the detection operation by the detection circuit 26. FIG. 5B illustrates a scale 5a printed on the surface of the measure 5 and the detection circuit 26 on the sub-substrate 71. The detection circuit 26 includes the light emitting element 260 and the light receiving element 261 facing the surface of the measure 5, and detects the pulling-out of the measure 5.

The light emitting element 260 irradiates the surface of the measure 5 with light Ls′. The light Ls' is reflected on the surface of the measure 5 to become the reflected light Lr′. The reflected light Lr′ is incident on the light receiving element 261.

When the measure 5 is pulled out in the direction D, an irradiation position of the light Ls′ on the surface of the measure 5 is alternately switched between the scale 5a and a portion other than the scale 5a. On the other hand, when the measure 5 is stopped without being pulled out, the irradiation position of the light Ls′ from the light emitting element 260 is constant.

For example, the scale 5a of the measure 5 is black, and the portion other than the scale 5a in the measure 5 is white. Since the light Ls′ of the light emitting element 260 is absorbed when illuminating the black scale 5a, the amount of the reflected light Lr′ incident on the light receiving element 261 is reduced when the light Ls′ illuminates the scale 5a rather than when the light Ls′ illuminates the portion other than the scale 5a.

The amount of the reflected light Lr′ incident on the light receiving element 261 is substantially constant when the measure 5 is stopped without being pulled out, but changes so as to repeatedly increase and decrease while the measure 5 is being pulled out. Therefore, the current value output from the light receiving element 261 is also substantially constant when the measure 5 is stopped without being pulled out, but changes so as to repeatedly increase and decrease while the measure 5 is being pulled out. The voltage value obtained from the current value is also similar to this.

Therefore, the calculation unit 10 and the determination unit 11 can determine whether the measure 5 is being pulled out according to the change in the voltage value of the light receiving element 261. The light emitting element 260 and the light receiving element 261 use visible light, but are not limited to it, and infrared, visible light, ultraviolet light or the like can be used to perform the same detection as described above.

The determination unit 11 determines an abnormality when the rotation speed of the reel 6 does not change even though the measure 5 is being pulled out, or when the rotation number of the reel 6 changes even though the measure 5 is stopped. Further, the determination unit 11 determines that the rotation of the reel 6 is normal when the rotation number of the reel 6 changes while the measure 5 is being pulled out, or when the rotation number of the reel 6 does not change in a state where the measure 5 is stopped.

In this way, the detection circuit 26 detects the pulling-out of the measure 5 from the cases 90 and 91. The determination unit 11 determines the normality of rotation of the reel 6 based on the detection result of the detection circuit 26 and the change in the value of the code pattern 60a read by the reading sensor 701.

Therefore, the measuring device can detect a failure of the reel 6 due to deterioration over time, for example. Since the display unit 21 displays the abnormality about the rotation of the reel 6 as an alarm, the user can receive the alarm, and repair the reel 6 or replace the reel 6 with a new reel 6, for example.

Next, the operation of the microcomputer 1 is described.

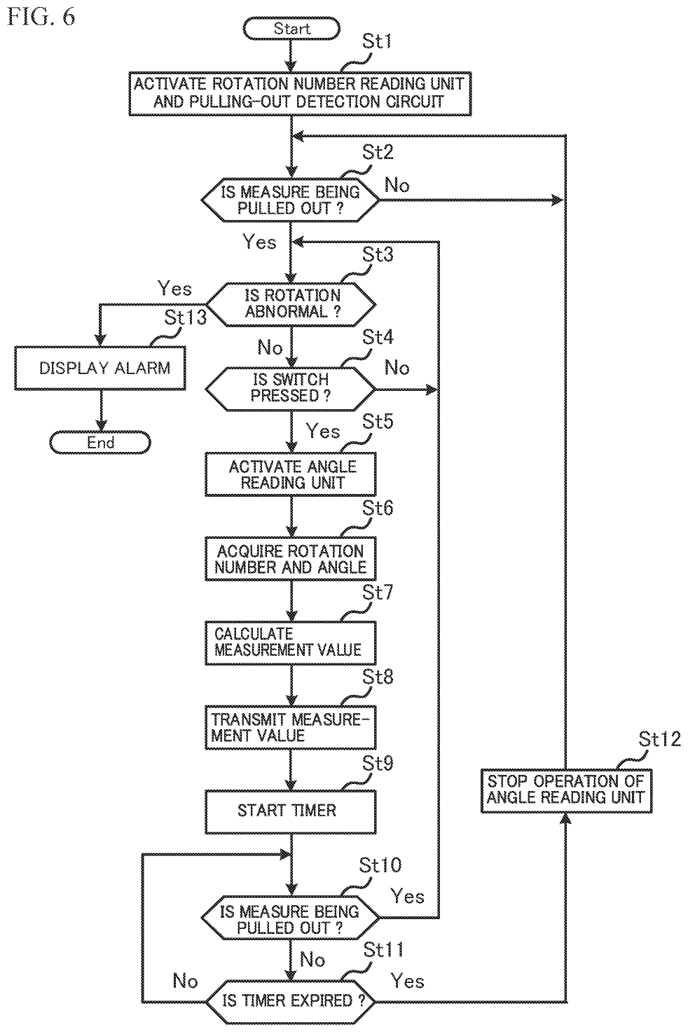

FIG. 6 is a flowchart illustrating an example of the operation of the microcomputer 1. When the measuring device is turned on, the control unit 12 activates the reading unit 25 and the detection circuit 26 (St1). The control unit 12 controls power supply to the reading unit 25 and the detection circuit 26 by turning on and off electric switches of the reading unit 25 and the detection circuit 26, for example, and activates them, but the control unit 12 is not limited to this.

Next, the calculation unit 10 determines whether the measure 5 is being pulled out by the detection circuit 26 (St2). When the measure 5 is not being pulled out (No in St2), the process of step St2 is executed again.

When the measure 5 is being pulled out (St2 Yes), the calculation unit 10 determines whether the rotation of the reel 6 is abnormal based on a determination result of the determination unit 11 (St3). When the calculation unit 10 determines that the rotation of the reel 6 is abnormal (Yes in St3), the calculation unit 10 causes the display unit 21 to display the alarm (St13). Thereby, the user is notified of the abnormality of the reel 6.

Further, when the rotation of the reel 6 is normal (St3 No), the calculation unit 10 determines whether the switch 22 is pressed (St4). When the switch 22 is not pressed (No in St4), the process of step St3 is executed again. When the switch 22 is pressed (Yes in St4), the control unit 12 activates the reading unit 24 (St5). The control unit 12 controls power supply to the reading unit 24 by turning on and off an electric switch of the reading unit 24, for example, and activates it, but the control unit 12 is not limited to this.

Next, the calculation unit 10 acquires the rotation number and the angle of the reel 6 from the reading result from the reading sensor 701 (St6). At this time, the calculation unit 10 converts the current values output from the light emitting elements 240 and 250 and the light receiving elements 241 and 251 into voltage values to acquire the rotation number and the angle of the reel 6.

Next, the calculation unit 10 calculates the measurement value of the measure 5 from the rotation number and the angle of the reel 6 (St7). Since the rotation number and the angle of the reel 6 are determined according to a pulled-out length of the measure 5, the measurement value of the measure 5 is calculated from the rotation number and the angle of the reel 6 based on a predetermined calculation formula.

Next, the communication processing unit 20 transmits the measurement value of the measure 5 to the other device (St8). Next, the control unit 12 starts a timer (St9). Next, the control unit 12 determines whether the measure 5 is being pulled out from the detection result of the detection circuit 26 (St10). When the measure 5 is being pulled out (Yes in St10), each process after step St3 is executed again.

When the measure 5 is not being pulled out (No in St10), the control unit 12 determines whether the timer is expired (St11). When the timer is not expired (No in St11), the process of St10 is executed again.

Further, when the timer is expired (Yes in St11), the control unit 12 stops the power supply to the reading unit 24 so that the operation is stopped (St12). In this way, the control unit 12 activates the reading unit 24 only when the switch 22 is pressed to take a measurement by the measure 5, and stops the power supply to the reading unit 24 when the expiration time of the timer elapses after the measurement. That is, the reading unit 24 is powered only at the time of measurement. Therefore, the power consumption of the reading unit 24 is reduced as compared with the case where the power is constantly supplied. Then, the process of step St2 is executed again.

Next, the process for determining the normality of the rotation of the reel 6 in St3 is described.

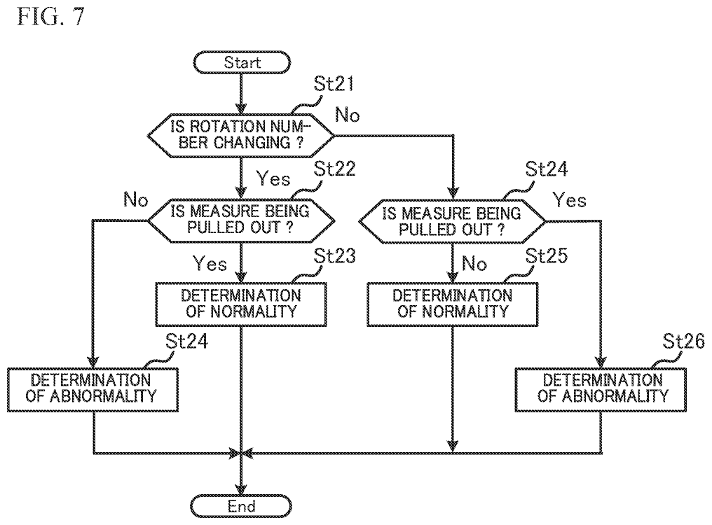

FIG. 7 is a flowchart illustrating an example of the determination process of the rotation of the reel. The determination unit 11 determines whether the rotation number of the reel 6 is changing based on the value of the lane 611 on the code pattern 60a read by the reading unit 25 (St21).

When the rotation number of the reel 6 is changing (Yes in St21), the determination unit 11 determines whether the measure 5 is being pulled out based on the detection result of the detection circuit 26 (St22). When it is determined that the measure 5 is not being pulled out (No in St22), since the reel 6 may be idling even though the measure 5 is stopped, the determination unit 11 determines that the rotation of the reel 6 is abnormal (St24).

Further, when the measure 5 is being pulled out (Yes in St22), the determination unit 11 determines that the rotation of the reel 6 is normal (St23).

Further, when the rotation speed of the reel 6 is not changing (No in St21), the determination unit 11 determines whether the measure 5 is being pulled out based on the detection result of the detection circuit 26 (St24). When the measure 5 is not being pulled out (No in St24), the determination unit 11 determines that the rotation of the reel 6 is normal (St25).

Further, when the measure 5 is being pulled out (Yes in St24), the reel 6 is stopped even though the measure 5 is being pulled out, and hence the determination unit 11 determines that the rotation of the reel 6 is abnormal (St26). In this way, the process of determining the normality of the rotation of the reel 6 is executed.

In this way, the determination unit 11 determines that the rotation of the reel 6 is abnormal when the rotation of the reel 6 and the pulling-out of the measure 5 do not cooperate with each other. Therefore, it is possible to detect the failure of the reel 6.

The embodiments described above are examples of preferred embodiments of the present invention. However, the present invention is not limited to those, and various changes and modifications may be made to the embodiments without departing from the scope of the invention disclosed in the claims.

### EXPLANATION OF REFERENCES

1 microcomputer
5 measure
6 reel
10 calculation unit
11 determination unit
20 communication processing unit
26 detection circuit
60a code pattern
80 cover
90, 91 case
610,611 lane
701 reading sensor

1. A measuring device comprising:
a measure;
a reel around which the measure is wound, the reel rotating according to pulling-out of the measure and being provided with a code pattern that changes along a rotation direction;
a reader configured to optically read the code pattern; and
a calculator configured to calculate a measurement value of the measure from a reading result by the reader.

2. The measuring device according to claim 1, wherein
the reader reads the code pattern according to presence or absence of a hole on a side surface of the reel.

3. The measuring device according to claim 1, wherein
the code pattern has a region indicating a rotation angle of the reel and a region indicating a rotation number of the reel, and
the calculator calculates the measurement value from the rotation angle and the rotation number of the reel.

4. The measuring device according to claim 1, further comprising:
a detector configured to detect the pulling-out of the measure from the measuring device; and
a determinator configured to determine normality of the rotation of the reel based on a detection result of the detector and a change in the value read by the reader.

5. The measuring device according to claim 1, further comprising:
a first case and a second case that are detachable from each other;
wherein the first case houses the reel around which the measure is wound, and the second case houses the reader and the calculator.

6. The measuring device according to claim 1, further comprising:
a transmitter configured to transmit the measurement value to another device.
